(19) United States
(12) Patent Application Publication
(10) Pub. No.: US 2025/0202574 A1
(43) Pub. Date: Jun. 19, 2025

(54) TECHNIQUES FOR COMMUNICATIONS USING MULTIPLE ANTENNAS

(71) Applicant: Viasat, Inc., Carlsbad, CA (US)

(72) Inventor: Eric L. Cross, Alpharetta, GA (US)

(21) Appl. No.: 18/847,416

(22) PCT Filed: Mar. 17, 2022
(86) PCT No.: PCT/US2022/020806

§ 371 Date: Sep. 16, 2024

(51) Int. Cl. H04B 7/185; H04B 7/06

(52) U.S. Cl. CPC H04B 7/18547; H04B 7/0617; H04B 7/18541

(57) ABSTRACT

An antenna system may be configured with multiple antennas that may be used in combination (e.g., for communication with a common target device), or separately (e.g., for communication with different target devices). In some examples, using the antennas in combination may include a coupling with a common modem for signal reception (e.g., to increase reception gain). In some such examples, a single antenna may be used for signal transmission (e.g., to reduce interference associated with simultaneous transmission toward a common target device). Using the antennas separately may facilitate handover or other communication transition scenarios, such as establishing a communication link with a new target device before breaking an established communication link with another target device. Some such implementations may involve antennas associated with a mechanical positioning axis for one direction of beam alignment (e.g., azimuth orientation) and a beamforming axis for another direction of beam alignment (e.g., elevation orientation).

### CROSS REFERENCE

The present Application is a 371 national phase filing of International Patent Application No. PCT/US2022/20806 by CROSS entitled, “TECHNIQUES FOR COMMUNICATIONS USING MULTIPLE ANTENNAS,” filed Mar. 17, 2022, which is assigned to the assignee hereof and which is hereby incorporated by reference in its entirety.

### BACKGROUND

Antenna systems can include multiple antennas, which may be implemented to support communications with multiple targets, or support communications using different frequency bands, among other configurations. For example, in applications where a user terminal moves between coverage areas of different satellites, or where coverage areas of satellites move in accordance with an orbital path of the satellites, each of the multiple antennas of the user terminal may be used to individually communicate with one of the satellites. However, in some such applications, one antenna may be idle or unused while another antenna is supporting communications.

### SUMMARY

Methods, systems, and devices are described for communications using multiple antennas. A multiple antenna system may support one or more beams which, in accordance with various examples as disclosed herein, may refer to transmit beams, or receive beams, or both that are supported by one of the antennas, or by multiple antennas, depending on various operating conditions. For example, in an illustrative implementation, a multiple antenna system of a user terminal may support a communication link with a first target device using a beam of the multiple antenna system that is supported by both a first antenna and a second antenna (e.g., a collective or cumulative beam, a combination of a beam of the first antenna and a beam of the second antenna that are both aligned with the target device). In some implementations, such operations may be supported by coupling both the first antenna and the second antenna with a same modem (e.g., a common modem) of the user terminal, which may leverage a collective reception sensitivity associated with the first antenna and the second antenna, or a collective transmission or reception power associated with the first antenna and the second antenna, or both.

In some examples, a determination may be made to establish communications between the user terminal and a second target device, which may involve establishing a communication link supported by another beam of the multiple antenna system (e.g., an additional beam). In some such examples, to provide the other beam, the second antenna may be decoupled (e.g., electrically) from the modem and oriented (e.g., physically, mechanically) toward the second target device, which may be performed while the first antenna remains coupled (e.g., electrically) with the modem and oriented (e.g., physically, mechanically) toward the first target device, thereby enabling communications to be maintained with the first target device during aspects of the link establishment with the second target device. In various examples, to support such a link establishment with the second target device, the second antenna may be coupled with a different modem than the first antenna, or the first antenna and the second antenna may be intermittently coupled with a same modem (e.g., in accordance with a time domain switching or multiplexing configuration). In some examples, after establishing a communications link with the second target device using the second antenna, the first antenna may be oriented toward the second target device, which may enable communication with the second target device to be supported by both the first antenna and the second antenna. Accordingly, a multiple antenna system in accordance with examples as disclosed herein may support a make-before-break handover or other transition of communications among multiple target devices, while also supporting the combination of multiple antennas to leverage a combined reception sensitivity, or a combined transmission power, or both, under various conditions.

To support the techniques described herein, a multiple antenna system may include various mechanisms, electronics, or both for forming or aligning one or more beams of the multiple antenna system with a target device. For example, one or more of the antennas may be mechanically oriented or positioned using a respective positioning mechanism (e.g., supporting separate or independent mechanical positioning of each antenna). In some examples, such a positioning mechanism may be associated with a single degree of freedom, such as an azimuth degree of freedom (e.g., for positioning or rotating an antenna about an azimuth axis, for aligning or orienting a signaling direction of the antenna about an azimuth axis). In some examples, the multiple antenna system may implement electronic beamforming to align or orient a signaling direction (e.g., a beam) of the one or more antennas about a different degree of freedom than the respective positioning mechanisms, such as an elevation degree of freedom (e.g., for beamforming about an elevation axis).

In some examples, one or more antennas of a multiple antenna system may implement a respective array of antenna elements that are arranged in a tilted orientation (e.g., in an arrangement associated with a fixed tilt relative to a base), such that each antenna may be associated with a tilted nominal orientation or boresight (e.g., a boresight or nominal beam orientation associated with a non-zero elevation or an off-of-zenith angle). Such tilting may improve coverage for non-overhead orientations (e.g., for orientations toward a horizon or otherwise horizontal orientation) without involving a mechanical or physical positioner along a corresponding axis (e.g., to avoid or omit a physical positioning capability about an elevation axis). Such an arrangement may be an example of an antenna having a directional physical characteristic or signaling asymmetry that may be oriented using a positioning mechanism (e.g., for aligning or positioning a fixed tilt along a desired azimuth direction). Thus, in some examples, a multiple antenna system in accordance with examples as disclosed herein may implement a respective positioning mechanism for each antenna (e.g., having a directional physical characteristic, such as a fixed tilt) to orient a signaling direction of the antenna about a first single axis, and implement a respective a beamformer for each antenna to orient the signaling direction about another single axis, which may provide a suitable tradeoff between one or more of: cost, performance, complexity, power consumption, heat generation, or physical envelope, among other tradeoffs.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

FIG. 1 illustrates an example of a communication system that supports techniques for communications using multiple antennas in accordance with examples as disclosed herein.

FIG. 2 illustrates an example of a multiple antenna system that supports techniques for communications using multiple antennas in accordance with examples as disclosed herein.

FIG. 3 illustrates an example of a method that supports techniques for communications using multiple antennas in accordance with examples as disclosed herein.

FIG. 4 shows a flowchart illustrating a method or methods that support techniques for communications using multiple antennas in accordance with examples as disclosed herein.

### DETAILED DESCRIPTION

Methods, systems, and devices are described for communications using multiple antennas. A multiple antenna system may support one or more beams which, in accordance with various examples as disclosed herein, may refer to transmit beams, or receive beams, or both that are supported by one of the antennas, or by multiple antennas, depending on various operating conditions. For example, in an illustrative implementation, a multiple antenna system of a user terminal may support a communication link with a first target device using a beam of the multiple antenna system that is supported by both a first antenna and a second antenna (e.g., a collective or cumulative beam, a combination of a beam of the first antenna and a beam of the second antenna that are both aligned with the target device). In some implementations, such operations may be supported by coupling both the first antenna and the second antenna with a same modem (e.g., a common modem) of the user terminal, which may leverage a collective reception sensitivity associated with the first antenna and the second antenna, or a collective transmission power associated with the first antenna and the second antenna, or both.

In some examples, a determination may be made to establish communications between the user terminal and a second target device, which may involve establishing a communication link supported by another beam of the multiple antenna system (e.g., an additional beam). In some such examples, to provide the other beam, the second antenna may be decoupled (e.g., electrically) from the modem and oriented (e.g., physically, mechanically) toward the second target device, which may be performed while the first antenna remains coupled (e.g., electrically) with the modem and oriented (e.g., physically, mechanically) toward the first target device, thereby enabling communications to be maintained with the first target device during aspects of the link establishment with the second target device. In various examples, to support such a link establishment with the second target device, the second antenna may be coupled with a different modem than the first antenna, or the first antenna and the second antenna may be intermittently coupled with a same modem (e.g., in accordance with a time domain switching or multiplexing configuration). In some examples, after establishing a communications link with the second target device using the second antenna, the first antenna may be oriented toward the second target device, which may enable communication with the second target device to be supported by both the first antenna and the second antenna. Accordingly, a multiple antenna system in accordance with examples as disclosed herein may support a make-before-break handover or other transition of communications among multiple target devices, while also supporting the combination of multiple antennas to leverage a combined reception sensitivity, or a combined transmission power, or both, under various conditions.

To support the techniques described herein, a multiple antenna system may include various mechanisms, electronics, or both for forming or aligning one or more beams of the multiple antenna system with a target device. For example, one or more of the antennas may be mechanically oriented or positioned using a respective positioning mechanism (e.g., supporting separate or independent mechanical positioning of each antenna). In some examples, such a positioning mechanism may be associated with a single degree of freedom, such as an azimuth degree of freedom (e.g., for positioning or rotating an antenna about an azimuth axis, for aligning or orienting a signaling direction of the antenna about an azimuth axis). In some examples, the multiple antenna system may implement electronic beamforming to align or orient a signaling direction (e.g., a beam) of the one or more antennas about a different degree of freedom than the respective positioning mechanisms, such as an elevation degree of freedom (e.g., for beamforming about an elevation axis).

In some examples, one or more antennas of a multiple antenna system may implement a respective array of antenna elements that are arranged in a tilted orientation (e.g., in an arrangement associated with a fixed tilt relative to a base), such that each antenna may be associated with a tilted nominal orientation or boresight (e.g., a boresight or nominal beam orientation associated with a non-zero elevation or an off-of-zenith angle). Such tilting may improve coverage for non-overhead orientations (e.g., for orientations toward a horizon or otherwise horizontal orientation) without involving a mechanical or physical positioner along a corresponding axis (e.g., to avoid or omit a physical positioning capability about an elevation axis). Such an arrangement may be an example of an antenna having a directional physical characteristic or signaling asymmetry that may be oriented using a positioning mechanism (e.g., for aligning or positioning a fixed tilt along a desired azimuth direction). Thus, in some examples, a multiple antenna system in accordance with examples as disclosed herein may implement a respective positioning mechanism for each antenna (e.g., having a directional physical characteristic, such as a fixed tilt) to orient a signaling direction of the antenna about a first single axis, and implement a respective a beamformer for each antenna to orient the signaling direction about another single axis, which may provide a suitable tradeoff between one or more of cost, performance, complexity, power consumption, heat generation, or physical envelope, among other tradeoffs.

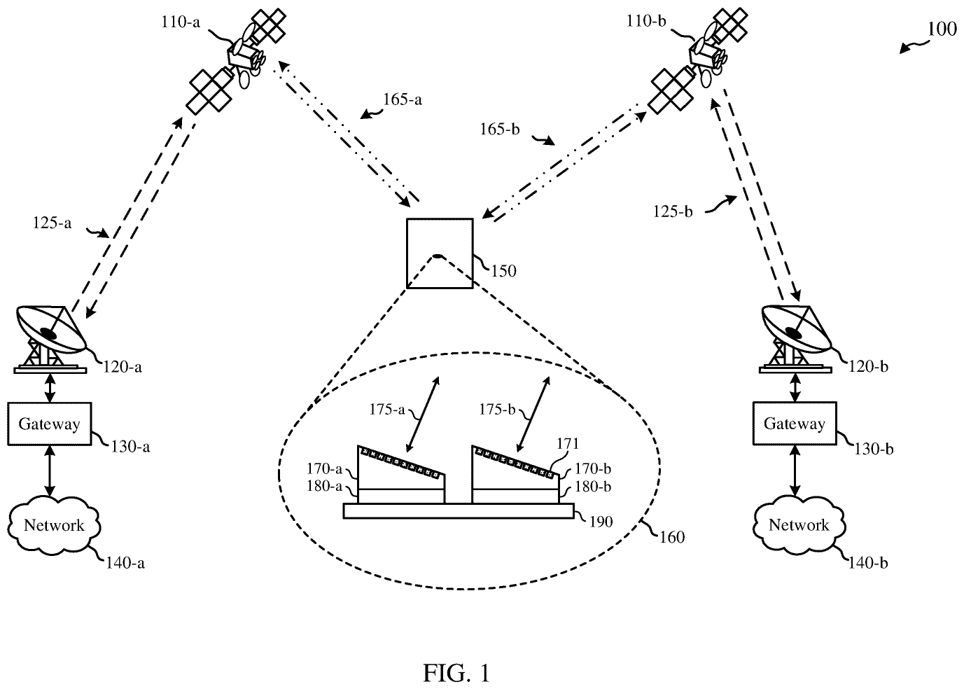

FIG. 1 illustrates an example of a communication system 100 in accordance with examples as disclosed herein. The communication system 100 includes a first satellite 110-a, a first gateway 130-a, a first gateway antenna system 120-a, and a user terminal 150. The first gateway 130-a may communicate with a first network 140-a. In operation, the communication system 100 can provide for one-way or two-way communications between the user terminal 150 and the first network 140-a through at least the first satellite 110-a and the first gateway 130-a. The user terminal 150 may be illustrative of various implementations, such as a fixed user terminal (e.g., a fixed installation, a user terminal installed at a building or other structure, a temporarily installed ground-based user terminal), or a mobile user terminal (e.g., a user terminal installed on a ground-based vehicle, a user terminal installed on an aircraft), among other examples.

In some examples, the communication system 100 includes a second satellite 110-b, a second gateway 130-b, and a second gateway antenna system 120-b. The second gateway 130-b may communicate with a second network 140-b. In operation, the communication system 100 can provide for one-way or two-way communications between the user terminal 150 and the second network 140-b through at least the second satellite 110-b and the second gateway 130-b.

The first satellite 110-a and the second satellite 110-b may each be any suitable type of communication satellite. In various examples, the first satellite 110-a or the second satellite 110-b may be in a geostationary orbit, a geosynchronous orbit, a low earth orbit (LEO), or a medium earth orbit (MEO), among other types of orbits or orbital characteristics. One or both of the first satellite 110-a or the second satellite 110-b may be a multi-beam satellite configured to provide service for multiple service beam coverage areas in a predefined geographical service area. In some examples, the first satellite 110-a and the second satellite 110-b may provide service in non-overlapping coverage areas, partially-overlapping coverage areas, or fully-overlapping coverage areas. In some examples, the communication system 100 may include more than two satellites 110. Although examples are described herein in the context of satellites 110 being a target device (e.g., targets of the user terminal 150), the techniques described herein may be implemented with other types of target devices that may support a communications service, which may include moving target devices (e.g., mobile ground-based target devices, aerial target devices, orbital target devices), stationary target devices (e.g., stationary ground-based target devices), or any combination thereof.

The first gateway antenna system 120-a may be one-way or two-way capable, and may be designed with adequate transmit power or receive sensitivity to communicate with the first satellite 110-a. The first satellite 110-a may communicate with the first gateway antenna system 120-a by transmitting or receiving signals via one or more beams 125-a (e.g., a transmit beam, a receive beam, or both, which may refer to a beam of the first satellite 110-a or a beam of the second gateway antenna system 120-a). The first gateway 130-a may transmit signals to the first satellite 110-a or receive signals from the first satellite 110-a via the first gateway antenna system 120-a. The first gateway 130-a may be connected to the first network 140-a. The first network 140-a may include a local area network (LAN), metropolitan area network (MAN), wide area network (WAN), or any other suitable public or private network and may be connected to other communications networks such as the Internet, or telephony networks (e.g., Public Switched Telephone Network (PSTN), etc.), among other networks.

Examples of the communication system 100 may include the second satellite 110-b, along with either unique or shared associated system components. For example, the second gateway antenna system 120-b may be one-way or two-way capable, and may be designed with adequate transmit power or receive sensitivity to communicate with the second satellite 110-b. The second satellite 110-b may communicate with the second gateway antenna system 120-b by transmitting or receiving signals via one or more beams 125-b (e.g., a transmit beam, a receive beam, or both, which may refer to a beam of the second satellite 110-b or a beam of the second gateway antenna system 120-b). The second gateway 130-b may transmit signals to the second satellite or receive signals from the second satellite 110-b via the second gateway antenna system 120-b. The second gateway 130-b may be connected to the second network 140-b. The second network 140-b may include a LAN, MAN, WAN, or any other suitable public or private network and may be connected to other communications networks such as the Internet, or telephony networks (e.g., PSTN, etc.), among other networks.

In various examples, the first network 140-a and the second network 140-b may be different networks, or the same network 140. Additionally, or alternatively, in various examples, the first gateway 130-a and the second gateway 130-b may be different gateways, or the same gateway 130. Additionally, or alternatively, in various examples, the first gateway antenna system 120-a and the second gateway antenna system 120-b may be different gateway antenna systems, or the same gateway antenna system 120.

The user terminal 150 may support communications using a multiple antenna system 160. The multiple antenna system 160 may include, for instance, a first antenna 170-a and a second antenna 170-b. However, the described techniques may be implemented using any quantity of two or more antennas 170. Each antenna 170 may be associated with a respective beam 175, which may correspond to a signaling direction for transmission of the antenna 170 (e.g., a transmit beam, a direction of peak transmission power), or a signaling direction for reception of the antenna 170 (e.g., a receive beam, a direction of peak reception sensitivity), or both. Although each antenna 170 is illustrated with a single beam 175, an antenna 170 may support multiple beams 175, which may or may not be aligned along a same direction (e.g., where a transmit beam may be aligned along a different direction than a receive beam, where multiple transmit beams may be aligned along different directions, where multiple receive beams may be aligned along different directions, or any combination thereof). In some examples, an antenna 170 can be a planar horn antenna array, a patch element array, or another type of antenna having a phased array of antenna elements 171 (e.g., feed elements, transducers, transducer apertures). Alternatively, an antenna 170 can be a different type or configuration of antenna. In some implementations, at least a portion of the multiple antenna system 160 may be mounted on the outside of a body or fuselage of a vehicle (e.g., a ground-based vehicle, an aircraft), which may be located under a radome (not shown).

In some examples, an antenna 170 may operate in the International Telecommunications Union (ITU) Ku, K, or Ka-bands, for example from approximately 17 to 31 Giga-Hertz (GHz). Additionally, or alternatively, an antenna 170 may operate in other frequency bands such as C-band, X-band, S-band, L-band, and the like. In various examples, the first antenna 170-a and the second antenna 170-b may be configured to operate in different frequency bands, or in the same frequency band, which may implement aspects of a static configuration, or a dynamic configuration, or both. In some examples, the first antenna 170-a and the second antenna 170-b may be configured with different dimensions, or other characteristics that may be leveraged in different communications circumstances. For example, the first antenna 170-a may be relatively smaller and have a relatively lower transmission or reception directionality (e.g., relatively lower beam gain, relatively broader beam focus), and the second antenna 170-b may be relatively larger and have a relatively greater transmission or reception directionality (e.g., relatively higher beam gain, relatively tighter beam focus), among other differences in configuration between the first antenna 170-a and the second antenna 170-b. In some examples, an antenna 170 may be configured with a physical characteristic that is directional in nature, such as a characteristic that varies for different signaling directions relative to the antenna itself (e.g., a directional orientation or pattern of antenna elements 171), which may be physically oriented by a positioner.

The multiple antenna system 160 may support one or more beams 165 which, in accordance with various examples as disclosed herein, may refer to transmit beams or receive beams or both that are supported by one of the antennas 170 (e.g., where a beam 165 corresponds to signal transmission or reception of a single antenna 170, where a beam 165 corresponds to a beam 175 of a single antenna 170), or by multiple antennas 170 (e.g., where a beam 165 corresponds to signal transmission or reception of multiple antennas 170, where a beam 165 corresponds to a combination of respective beams 175 of multiple antennas 170 that are aligned with a common target device), depending on various operating conditions. For example, in an illustrative implementation, the multiple antenna system 160 may support a communication link with the first satellite 110-a using a beam 165-a that is supported by both the first antenna 170-a and the second antenna 170-b (e.g., supported by the beam 175-a and the beam 175-b, which may both be aligned with the first satellite 110-a). In some implementations, such operations may be supported by coupling both the first antenna 170-a and the second antenna 170-b with a common modem, which may leverage a collective reception sensitivity associated with the first antenna 170-a and the second antenna 170-b, or a collective transmission power associated with the first antenna 170-a and the second antenna 170-b, or both.

In some examples, a determination may be made (e.g., by the multiple antenna system 160, by the user terminal 150, or by another entity of the communication system 100) to at least partially hand over, to supplement with, or to otherwise establish communications between the user terminal 150 and the second satellite 110-b, which may involve establishing a communication link using a beam 165-b. In some such examples, to provide the beam 165-b, the second antenna 170-b, or a beam thereof (e.g., the beam 175-b), may be oriented toward the second satellite 110-b, which may be performed while the first antenna 170-b, or a beam thereof (e.g., the beam 175-a), is oriented toward the first satellite 110-a, thereby enabling communications to be maintained via the first satellite 110-a during aspects of the link establishment with the second satellite 110-b. In various examples, to support such a link establishment with the second satellite 110-b, the second antenna 170-b may be coupled with a different modem than the first antenna 170-b, or the first antenna 170-a and the second antenna 170-b may be intermittently coupled with a same modem (e.g., in accordance with a time domain switching or multiplexing configuration). In some examples, after establishing a communications link with the second satellite 110-b using the second antenna 170-b (e.g., the beam 175-b), the first antenna 170-a, or a beam thereof (e.g., the beam 175-a), may be oriented toward the second satellite 110-b, which may enable the beam 165-b to also be supported by both the first antenna 170-a and the second antenna 170-b. Accordingly, the multiple antenna system 160 may support a make-before-break handover or other transition of communications from among multiple satellites 110, or other target devices, while also supporting the combination of multiple antennas to leverage a combined reception sensitivity, or a combined transmission power, or both.

To support the techniques described herein, the multiple antenna system 160 may include various mechanisms, electronics, or both for forming or aligning beams 165 or beams 175 of the multiple antenna system 160 with a satellite 110 or other target device. For example, the first antenna 170-a may be mechanically oriented or positioned relative to a base 190 using a positioning mechanism 180-a, and the second antenna 170-b may be mechanically oriented or positioned relative to the base 190 using a positioning mechanism 180-b. In some examples, each positioning mechanism 180 may be associated with a single degree of freedom, such as an azimuth degree of freedom (e.g., for aligning a beam 175 about an azimuth axis). In some examples, the multiple antenna system 160 may implement electronic beamforming to align or orient respective beams 175 of the antennas 170-a and 170-b about a different degree of freedom than the respective positioning mechanisms 180, such as an elevation degree of freedom. For example, the beam 175-a may be electronically steered or aligned in a vertical direction (e.g., about an elevation axis) relative to the base 190 using a first beamformer (not shown), and the beam 175-b may be electronically steered or aligned in the vertical direction relative to the base 190 using a second beamformer (not shown).

In some examples, the antennas 170 may implement a tilted array of antenna elements 171 (e.g., associated with a fixed tilt relative to the base 190), such that each antenna 170 may be associated with a tilted nominal orientation or boresight (e.g., a boresight or nominal beam orientation associated with a non-zero elevation or an off-of-zenith angle). In some examples, such tilting may improve coverage (e.g., reception sensitivity, transmission power, or both) toward a horizon or other non-overhead orientations, which may be associated with a physical alignment of beamforming capability or characteristic, such as a physical orienting of a beamforming rolloff or other characteristic, relative to a beamforming axis. Although a 45 degree tilt may be implemented to equalize coverage of an antenna 170 between an overhead alignment and a horizontal alignment, other angles may be selected (e.g., a tilt of less than 45 degrees, a tilt of more than 45 degrees) depending on various design considerations. For example, when generally overhead communications are more likely or are of a higher priority, an array tilt of 15 degrees or 30 degrees from horizontal (e.g., associated with an 85 degree nominal elevation or a 60 degree nominal elevation) may be selected, among other tilt angles. Further, although the antennas are 170 are illustrated with planar arrays of antenna elements 171, a surface or aperture of antenna elements 171 may be configured with other shapes, such as a stepped or curved pattern of antenna elements 171.

In various examples, a fixed tilt of antenna elements 171 may support aligning a physical beamforming characteristic of an antenna 170 without involving a mechanical or physical positioner, which may support avoiding or omitting a physical positioning capability about an elevation axis. Such an arrangement may be an example of an antenna 170 having a directional physical characteristic or a signaling asymmetry that may be oriented using a positioning mechanism 180 (e.g., for aligning or positioning a fixed tilt along a desired azimuth direction), which may take the place of a beamforming capability about the same axis (e.g., to avoid involving a beamforming capability in an azimuth direction, which may otherwise involve a flat or horizontal array of antenna elements 171 that does not provide suitable coverage in a horizontal direction). Thus, in some examples, the multiple antenna system may implement a respective positioning mechanism 180 for each antenna 170 to orient a beam 175 about a single positioning axis (e.g., and orient a directional physical characteristic of the antenna 170 about the same single positioning axis), and implement a respective a beamformer for each antenna 170 to orient the beam 175 about another single positioning axis, which may provide a suitable tradeoff between one or more of cost, performance, complexity, power consumption, heat generation, and physical envelope, among other tradeoffs.

The example of multiple antenna system 160 provides an illustrative arrangement of associated components, and may include various modifications or alternatives that support the described techniques. For example, although the antennas 170 are illustrated as being located at a same height relative to the base 190, in some examples, one antenna 170 may be located at a different height than another antenna 170. Moreover, a multiple antenna system 160 may include other antennas 170, which may or may not include the same configurations for orienting respective signaling directions. For example, a multiple antenna system 160 may include additional antennas 170 that are configured with an electronic beamforming capability about an elevation axis and about an azimuth axis (e.g., without a mechanical positioner), which may support further communications flexibility (e.g., for communications with a target device that is generally in an overhead location, for communications with a target device using a different frequency band than the antennas 170).

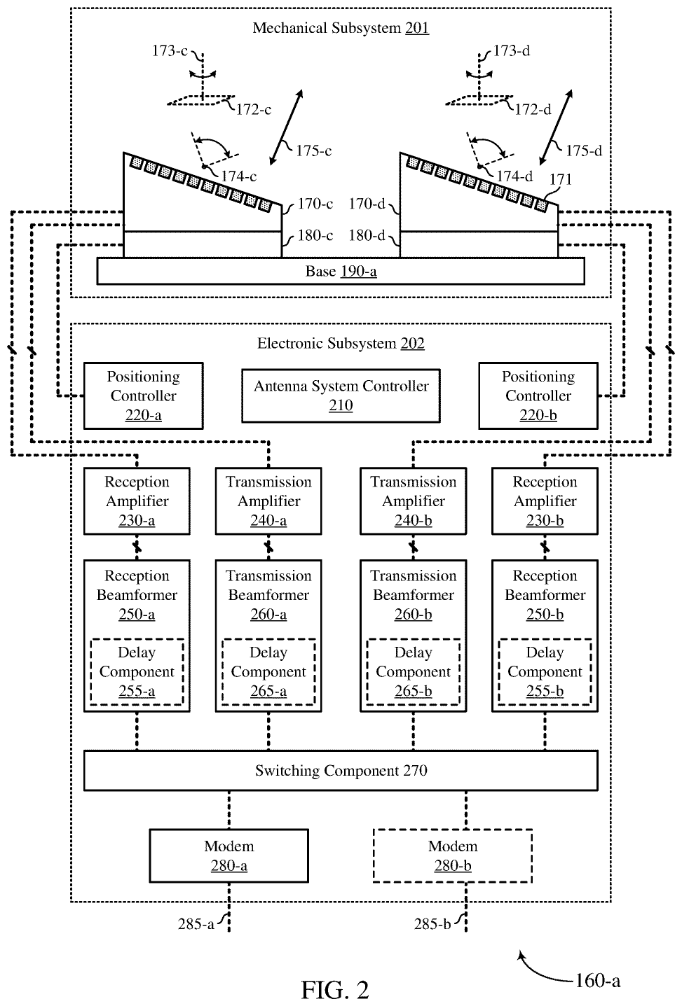

FIG. 2 illustrates an example of a multiple antenna system 160-a that supports techniques for communications using multiple antennas in accordance with examples as disclosed herein. The multiple antenna system 160-a may be an example for implementing a multiple antenna system 160 as described with reference to FIG. 1. The multiple antenna system 160-a may be described with reference to a mechanical subsystem 201 and an electronic subsystem 202. However, such descriptions or arrangements are for illustrative and descriptive purposes only, and the multiple antenna system 160-a may be implemented as other subsystems or arrangements in accordance with examples as disclosed herein. In some examples, the mechanical subsystem 201, or some portion thereof, may be installed on a vehicle (e.g., a ground-based vehicle, an aircraft), and the electronic subsystem 202 may be co-located with the mechanical subsystem 201, or may be located elsewhere on or inside the vehicle (e.g., in an electronics module). In some examples, the multiple antenna system 160-a may support communications of a user terminal 150 via one or more data lines 285, which each may be coupled with a respective modem 280, among other components of the electronic subsystem 202 (e.g., an antenna system controller 210).

The multiple antenna system 160-a may include a first antenna 170-c and a second antenna 170-d, each of which may be an example of an antenna 170 described with reference to FIG. 1. The antenna 170-c may be associated with a beam 175-c, and the antenna 170-d may be associated with a beam 175-d, each of which may correspond to a signaling direction for transmission of the respective antenna 170 (e.g., a transmit beam, a direction of peak transmission power), or a signaling direction for reception of the respective antenna 170 (e.g., a receive beam, a direction of peak reception sensitivity), or both.

The first antenna 170-c may be mechanically oriented or positioned relative to a base 190-a using a positioning mechanism 180-c, and the second antenna 170-cmay be mechanically oriented or positioned relative to the base 190-a using a positioning mechanism 180-b. In the example of the multiple antenna system 160-a, the positioning mechanism 180-c may be configured to rotate the antenna 170-c about a positioning axis 173-c (e.g., associated with a first rotational bearing), which may be perpendicular to a reference plane 172-c, and the positioning mechanism 180-d may be configured to rotate the antenna 170-d about a positioning axis 173-d (e.g., associated with a second rotational bearing), which may be perpendicular to a reference plane 172-d. In some examples, one or both of the reference plane 172-c or the reference plane 172-d may be a fixed horizontal reference plane (e.g., a global horizontal plane) or a reference plane generally aligned with a horizontal orientation of a user terminal 150 or associated assembly or structure (e.g., a vehicle-centric or vehicle-fixed horizontal plane). Thus, one or both of the positioning mechanism 180-c or the positioning mechanism 180-c may orient a respective antenna 170, or a beam 175 thereof, along an azimuth direction. In other words, the positioning mechanism 180-c, or the positioning mechanism 180-d, or both may be associated with controlling a direction of signaling about an azimuth axis or an azimuth degree of freedom. Each positioning mechanism 180 may include various components operable to perform a controlled rotation, such as an electric motor, a hydraulic motor, a gear motor, a belt-driven actuator, a gear-driven actuator, or a chain-driven actuator, among other examples, which may be controlled by a respective positioning controller 220-a (e.g., of the electronic subsystem 202).

In some examples, the multiple antenna system 160-a may implement electronic beamforming to align or orient respective directions of signaling of the antennas 170-c and 170-d about a different degree of freedom than the respective positioning mechanisms 180. For example, a beam 175-c of the first antenna 170-c may be electronically steered or aligned relative to the base 190-a (e.g., using a first beamformer, which may include a reception beamformer 250, a transmission beamformer 260, or both), and a beam 175-d of the second antenna 170-d may be electronically steered or aligned relative to the base 190-a (e.g., using a second beamformer, which may include a reception beamformer 250, a transmission beamformer 260, or both). In some examples, a beamformer may also be associated with a single degree of freedom (e.g., for aligning a beam 175 of an antenna 170 about a single positioning axis). For example, a beamformer may be configured to orient the beam 175-c about a beamforming axis 174-c, which may be parallel with the reference plane 172-c, or perpendicular to the positioning axis 173-c, or both. Additionally, or alternatively, a beamformer may be configured to orient the beam 175-d about a beamforming axis 174-d, which may be parallel with the reference plane 172-d, or perpendicular to the positioning axis 173-d, or both. In some examples, the beamforming axis 174-c may be aligned along a different direction than the beamforming axis 174-d, which may be due to different rotational alignments of the antennas 170 about their respective positioning axis 173 (e.g., due to different alignments of the respective positioning mechanisms 180). In some examples, such beamformers may be configured to orient a beam 175 of a respective antenna 170 along an elevation direction. In other words, beamformers of the multiple antenna system 160-a may be associated with controlling a direction of signaling (e.g., of beams 175) about an elevation axis or an elevation degree of freedom.

In some examples, the antennas 170 may implement a tilted array of antenna elements 171 (e.g., associated with a fixed tilt relative to the base 190-a), such that each antenna 170 may be associated with a tilted nominal orientation or boresight (e.g., a boresight or nominal beam orientation associated with an elevation angle other than parallel or normal to a reference plane 172 of a positioning axis for a positioning mechanism 180). In some examples, such tilting may refer to a fixed tilt angle (e.g., non-zero or non-perpendicular) relative to a corresponding reference plane 172, or a fixed non-zero tilt orientation relative to a corresponding positioning axis 173, or a fixed non-zero angle or orientation as measured about a beamforming axis 174 (e.g., a tilt angle orientation that is neither horizontal nor vertical), or any combination thereof.

The multiple antenna system 160-a may include various components and arrangements to support communications via the antennas 170-c and 170-d in accordance with examples as disclosed herein. For example, signals received by the antenna 170-c may be communicated via a reception amplifier 230-a and a reception beamformer 250-a, and signals transmitted by the antenna 170-c may be communicated via a transmission amplifier 240-a and a transmission beamformer 260-a. Further, signals received by the antenna 170-d may be communicated via a reception amplifier 230-b and a reception beamformer 250-b, and signals transmitted by the antenna 170-d may be communicated via a transmission amplifier 240-b and a transmission beamformer 260-b. As illustrated, the multiple antenna system 160-a may be configured support bidirectional communications with one or more target devices. In implementations configured to support unidirectional communications, reception amplifiers 230 and reception beamformers 250 may be omitted (e.g., for transmission-only implementations), or transmission amplifiers 240 and transmission beamformers 260 may be omitted (e.g., for reception-only implementations). Although the example of multiple antenna system 160-a is illustrated as having respective amplifiers coupled between respective antennas 170 and respective beamformers, in some other examples, respective beamformers may be coupled between respective antennas 170 and respective amplifiers.

In the example of multiple antenna system 160-a, each antenna 170 may be associated with a respective reception amplifier 230 and a respective transmission amplifier 240. In some examples, a reception amplifier 230 may include or refer to one or more low-noise amplifiers (LNA). For example, a reception amplifier 230 may include an LNA for each antenna element 171 of the respective antenna 170, or some quantity of antenna elements 171 of the respective antenna 170 that support parallel signal reception (e.g., in accordance with a same signal phase and amplitude). In some examples, a transmission amplifier 240 may include or refer to one or more high-power amplifiers (HPA). For example, a transmission amplifier 240 may include an HPA for each antenna element 171 of the respective antenna 170, or some quantity of antenna elements 171 of the respective antenna 170 that perform parallel signal transmission (e.g., in accordance with a same signal phase and amplitude). In some other examples, reception amplification or transmission amplification for multiple antennas 170 may be supported by a single (e.g., combined, shared) reception amplifier 230, or a single transmission amplifier 240, or both that is coupled with multiple antennas 170. In some such examples, each of the antennas 170 may be selectively coupled with or isolated from such a single reception amplifier 230, or a single transmission amplifier 240, or both (e.g., via one or more switching components having a different configuration that the switching component 270, which may be coupled between the antennas 170 and the single reception amplifier 230, or a single transmission amplifier 240, or both).

In the example of multiple antenna system 160-a, each antenna 170 may be associated with a respective reception beamformer 250 and a respective transmission beamformer 260. A reception beamformer 250 may be associated with circuitry operable to apply phase and amplitude transformations on signals received from respective antenna elements 171, or subsets thereof, to support various aspects of directional reception, and output (e.g., to a modem 280) a collective or combined signal representative of a waveform received along a configured direction. A transmission beamformer 260 may be associated with circuitry operable to receive (e.g., from a modem 280) a signal for transmission along a configured direction, and apply respective phase and amplitude transformations to generate signals for transmission by respective antenna elements 171, or subsets thereof, to support various aspects of directional transmission. In some other examples, reception beamforming or transmission beamforming for multiple antennas 170 may be supported by a single (e.g., combined, shared) reception beamformer 250, or a single transmission beamformer 260, or both.

In some examples, the multiple antenna system 160-a may support delaying one or more signals conveyed via an antenna 170, which may be implemented to compensate for different signal propagation times when different cooperating antennas 170 are located at different distances from a target device. For example, a reception beamformer 250 may include a delay component 255 which, when multiple antennas 170 are being used for receiving signals from a common target device, may add a delay to one or more signals received from an antenna 170 that is closer to the target device (e.g., a delay equal to a difference in distance divided by a signal propagation velocity, a delay applied to signals before generating a combined signal provided to a modem). In various examples, such a delay may be applied equally to each signal received from respective antenna elements 171 (e.g., via a reception amplifier 230, prior to phase or amplitude transformations)), or applied to a signal resulting from the combination of phase or amplitude adjusted feed element signals (e.g., after phase or amplitude transformations, prior to being conveyed to a switching component 270). Additionally, or alternatively, a transmission beamformer 260 may include a delay component 265 which, when multiple antennas 170 are being used for transmitting signals to a common target device, may add a delay to signals to be transmitted by an antenna 170 that is closer to the target device (e.g., a delay equal to a difference in distance divided by a signal propagation velocity). In various examples, such a delay may be applied to a signal received from a modem 280 (e.g., prior to phase or amplitude transformations), or to each signal provided to respective antenna elements 171 (e.g., after phase or amplitude transformations). In some examples, the introduction of such delays may be implemented as part of beamforming operations performed by a reception beamformer 250 or a transmission beamformer 260 themselves, such as applying a configured phase delay or transformation across each of the antenna elements 171 of a given antenna 170, which may be additive to a phase transformation of a signal specific to a particular antenna element 171.

In some examples, the reception beamformer 250-b, the transmission beamformer 260-a, the reception beamformer 250-b, and the transmission beamformer 260-b may be selectively coupled with or selectively isolated from one or more modems 280 via a switching component 270. For example, the switching component 270 may include one or more transmission power splitters or switches, which may be operable to couple a modem 280 with the transmission beamformer 260-a (e.g., while isolating the transmission beamformer 260-b from the modem 280), or to couple a modem 280 with the transmission beamformer 260-b (e.g., while isolating the transmission beamformer 260-a from the modem 280), or to couple a modem 280 with both the transmission beamformer 260-a and the transmission beamformer 260-b. Additionally, or alternatively, the switching component 270 may include one or more reception power combiners or switches, which may be operable to couple a modem 280 with the reception beamformer 250-a (e.g., while isolating the reception beamformer 250-b from the modem 280), or to couple a modem 280 with the reception beamformer 250-b (e.g., while isolating the reception beamformer 250-a from the modem 280), or to couple a modem 280 with both the reception beamformer 250-a and the reception beamformer 250-b. In some implementations, the switching component 270 may support a time-division switching or multiplexing technique where a modem 280 may alternate between communications via the first antenna 170-c and the second antenna 170-d. Additionally, or alternatively, the switching component 270 may support techniques where one of modem 280-a or modem 280-b may be configured to support communications via the first antenna 170-c, and the other of the modem 280-a or modem 280-b may be configured to support communications via the second antenna 170-d.

In some examples, coupling or isolation between beamformers and a modem 280 may be supported by one or more electrical switches, relays, or other components of a switching component 270 that may provide a controllable electrical connection or disconnection, which may support various examples of selective coupling or isolation between a modem 280 and one or more antennas 170. However, such techniques may be supported by switching components in other locations (e.g., one or more switching components located between beamformers and amplifiers, one or more switching components between amplifiers and antennas 170, or any combination thereof), or by different types of circuit components or techniques. For example, a selective coupling or isolation between the antenna 170-c and the modem 280-a may be supported by any quantity of one or more switches or relays located along a signal path between the antenna 170-a and the modem 280-a, including a reception signal path (e.g., via the reception amplifier 230-a and the reception beamformer 250-a, or between multiple antennas 170 and a common reception amplifier 230), or a transmission signal path (e.g., via the transmission amplifier 240-a and the transmission beamformer 260-a, or between multiple antennas 170 and a common transmission amplifier 240), or both. In some examples, such a selective coupling or isolation may include or be otherwise accompanied by a selective powering of respective components, such as a selective power-up or power-down of a reception amplifier 230, of a transmission amplifier 240, of a reception beamformer 250, or a transmission beamformer 260, or any combination thereof.

In some examples, one or more aspects of the described techniques for selective coupling or isolation between antennas 170 and modems 280, among other operations of the multiple antenna system 160-a, may be performed by, controlled by, or otherwise supported by an antenna system controller 210. In various examples, the antenna system controller 210 may control aspects of the reception amplifiers 230 or transmission amplifiers 240 (e.g., for initiating power-up or power-down operations, for enabling or disabling amplifiers), or control aspects of the reception beamformers 250 or transmission beamformers 260 (e.g., for determining or communicating a direction of signaling, for determining or communicating beamforming coefficients, for determining or communicating a delay for respective delay components), or control aspects of one or more switching components (e.g., for controlling the switching component 270, for enabling or disabling switches or relays, for opening or closing electrical connections between antennas 170 and modems 280), among other operations. In some examples, the antenna system controller 210 may control aspects of one or more positioning controllers 220, which may include various control circuitry (e.g., encoders, servo controllers) for operating a positioning mechanism 180. In some examples, the antenna system controller 210 may manage aspects of communications more generally, including determining locations or paths of target devices (e.g., satellites 110), determining timing or circumstances associated with link establishment of communication links with one or more target devices, or determining handoff criteria, among other operations. In various examples, the antenna system controller 210 may perform such operations using information received via one or more data lines 285, or via one or more beams 175, among other information sources.

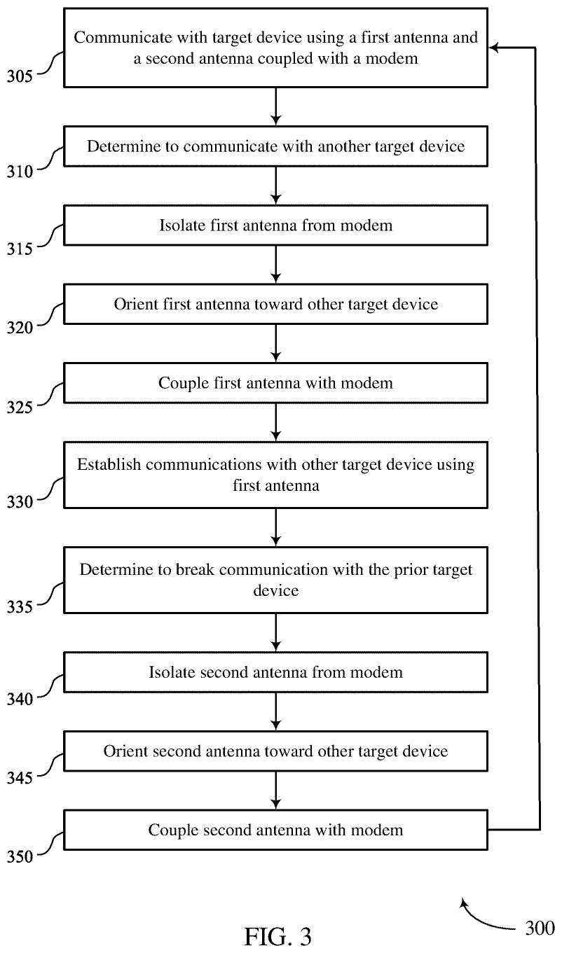

FIG. 3 illustrates an example of a method 300 that supports techniques for communications using multiple antennas in accordance with examples as disclosed herein. In some examples, the method 300 may be performed using a multiple antenna system 160, which may be implemented to support communications at a user terminal 150. For illustrative purposes, aspects of the method 300 may be described with reference to the features of the communication system 100 described with reference to FIG. 1 and the multiple antenna system 160-a described with reference to FIG. 2. In some examples, one or more aspects of the operations of the method 300 may be performed by, controlled by, or otherwise supported by an antenna system controller 210, which may be implemented in hardware, firmware, software, or various combinations thereof.

At 305, the method 300 may include communicating with a target device (e.g., a first target device, such as a satellite 110-a) using a first antenna 170 (e.g., antenna 170-c) and a second antenna 170 (e.g., antenna 170-d), which may be associated with communicating in accordance with a combined capability supported by the first antenna 170 and the second antenna 170. The combined capability may include combining signal power received via the first antenna 170 and the second antenna 170. In some examples, the communications of 305 may be supported by coupling the first antenna 170 and the second antenna 170, or associated supporting hardware (e.g., one or more reception beamformers 250, one or more transmission beamformers 260, one or more reception amplifiers 230, one or more transmission amplifiers 240), or any combination thereof with a same modem 280 (e.g., the modem 280-a). Such a coupling may be provided via a switching component 270, or another arrangement of one or more switching components (e.g., one or more switches, one or more relays) or one or more power combining components that provide an electrical or other communicative connection between the modem 280 and the first and second antennas 170. In some examples, such techniques may further include powering, enabling, or otherwise initiating an operable mode of the first antenna 170 and the second antenna 170, or the associated supporting hardware, or any combination thereof.

In some examples, the target device for the communications of 305 may be a satellite 110 associated with an orbital characteristic, such as a LEO, a MEO, or a geostationary orbit. In some other examples, the target device for the communications of 305 may be any other type of stationary target, or ground-based mobile target, or aerial or overhead target device, among other examples. In some examples, the target device for the communications of 305 may support the communications for a limited duration (e.g., associated with a line of sight or suitable orientation between the user terminal 150 and the satellite 110), which may be related to movement of the target device, movement of a user terminal 150 associated with the multiple antenna system 160, or both.

The communications of 305 may include aligning a signaling direction of the first antenna 170 and a signaling direction of the second antenna 170 toward the target device. In some examples, for each of the first antenna 170 and the second antenna 170, such aligning during the communications of 305 may include using a respective positioning controller 220 (e.g., via an antenna system controller 210) to control a respective positioning mechanism 180, which may control a rotation of the respective antenna 170 about a positioning axis 173 (e.g., to align a respective beam 175 along a desired azimuth direction).

In some examples, supporting the communications of 305 may include coupling both the first antenna 170 and the second antenna 170 with the modem 280 for receiving signals from the first target device (e.g., leveraging a combined reception sensitivity of the first antenna 170 and the second antenna 170, leveraging a combined reception power of the first antenna 170 and the second antenna 170, leveraging a combined reception amplification of multiple reception amplifiers 230). In some such examples, for each of the first antenna 170 and the second antenna 170, aligning a respective signaling direction may include using a respective reception beamformer 250 (e.g., via an antenna system controller 210) to align a signaling direction (e.g., a direction of peak reception sensitivity) about a beamforming axis 174 (e.g., to align a respective receive beam 175 along a desired elevation direction). Combining a reception sensitivity of the first antenna 170 and the second antenna 170 may be associated with a 3 dB improvement to reception sensitivity compared to reception using only one of the first antenna 170 or the second antenna 170 (e.g., provided the two antennas have the same reception gains).

In some examples, supporting the communications of 305 may include coupling both the first antenna 170 and the second antenna 170 with the modem 280 for transmitting signals to the first target device (e.g., leveraging a combined transmission power of the first antenna 170 and the second antenna 170, leveraging a combined transmission amplification of multiple transmission amplifiers 240). In some such examples, for each of the first antenna 170 and the second antenna 170, aligning a respective signaling direction may include using a respective transmission beamformer 260 (e.g., via an antenna system controller 210) to align a signaling direction (e.g., a direction of peak transmission power) about a beamforming axis 174 (e.g., to align a respective transmit beam 175 along a desired elevation direction). Combining a transmission power of the first antenna 170 and the second antenna 170 may be associated with a 3 dB improvement to transmission power compared to transmission using only one of the first antenna 170 or the second antenna 170 (e.g., provided the two antennas have the same transmission gains).

In some examples, supporting the communications of 305 may not include coupling both the first antenna 170 and the second antenna 170 with the modem 280 for transmitting signals to the first target device. For example, combined transmission by multiple antennas 170 may be associated with grating lobes or other constructive or destructive interference, which may be avoided by using only one of the first antenna 170 or the second antenna 170 for transmitting signals to the target device. Accordingly, in some examples, the communications of 305 may include coupling the first antenna 170 and the second antenna 170 with the modem 280 for signal reception (e.g., to leverage a combined reception sensitivity of the two antennas 170), but selecting either the first antenna 170 or the second antenna 170 for signal transmission (e.g., while the other of the first antenna 170 or the second antenna 170, or other supporting hardware, is isolated from the modem 280, to avoid transmission interference or other adverse behavior).

In some examples, the selection of one of the antennas 170 for signal transmission may be performed by an antenna system controller 210 based on various criteria. For example, the antenna system controller 210 may be configured to select between the first antenna 170 and the second antenna 170 based on transmission performance characteristics (e.g., for current conditions, for upcoming or anticipated conditions, based on selecting an antenna 170 supporting a higher quality transmission or having a physical or other configuration more suited to transmission to the target device). In some such examples, such a selection may be based on a position of the target device, or a position or orientation of the multiple antenna system 160 (e.g., a position or orientation of the user terminal 150, such as a yaw orientation or heading), or a relative position between the first antenna 170 and the second antenna 170 (e.g., where one antenna 170 is located relative to the other antenna 170 or relative to a direction towards the target device), or an alignment between each antenna 170 and the target device (e.g., an alignment of a beam 175), or a physical characteristic or capability of a respective antenna 170, among other criteria or combination thereof.

For example, a selection of one antenna 170 may be made to avoid transmitted signaling being blocked by the other antenna 170 (or some other component of the multiple antenna system 160), or interfering with signal reception by the other antenna 170, based on position or orientation information at the time of such a decision, or based on position or orientation information anticipated after such a decision (e.g., based on an understanding or prediction of a path of the target device, such as a known orbital path of a satellite 110). In some such examples, an antenna system controller 210 may support selecting the first antenna 170 or the second antenna 170 for signal transmission based at least in part on a relative position between the first antenna 170 and the second antenna 170 and either the aligned signaling direction of the first antenna 170 or the aligned signaling direction of the second antenna 170 (e.g., current aligned signaling directions, future aligned signaling directions). In some such examples, an antenna system controller 210 may support selecting the first antenna or the second antenna for signal transmission based at least in part on a relative proximity between the first antenna 170 and the target device, or a relative proximity between the second antenna and the first target device, or a combination thereof. For example, such a selection may include selecting the antenna 170 that is relatively closer to or is most likely to be closer to the target device, or otherwise less likely to experience self-interference at the multiple antenna system 160 or user terminal 150. In some examples, such a selection may include maintaining a selected antenna 170 for some duration, or within a certain range of alignment to avoid dithering between one antenna 170 and another antenna 170 (e.g., including a combination of a threshold or criteria for selecting one antenna 170 and a threshold or criteria for deselecting another antenna 170, such as a selection hysteresis configuration).

In some examples, a selection of an antenna 170 for signal transmissions may change during the communications of 305. For example, evaluations between one antenna 170 and another may be made continuously, intermittently, periodically, or based on a communications characteristic or other event, such that different antennas 170 may be selected for transmitting signals to the target device during the communication of 305 (e.g., when one antenna 170 blocks another, among other events or criteria). Accordingly, at one or more occasions during the communications of 305, the multiple antenna system 160 may, for signal transmissions, perform a selective coupling of one antenna 170 with the modem 280 while also performing a selective isolation of another antenna 170 from the modem 280. During such communications, the multiple antenna system 160 may maintain coupling of both the first antenna 170 and the second antenna 170 with the modem 280 for signal reception.

In some other examples, interference from using multiple antennas 170 for transmission may be problematic under some circumstances, but may not be problematic under some other circumstances. For example, it may be required or preferable to avoid using multiple antennas 170 for transmissions of certain frequencies, for communication with certain target devices, for transmissions aligned with or near other devices not intended to be targeted by the multiple antenna system 160, or for transmissions along certain directions, among other criteria. Additionally, or alternatively, under some circumstances, a transmission power from a single antenna 170 may be sufficient, but in some other circumstances a determination may be made to supplement transmission power by combining power from multiple antennas 170. Accordingly, an antenna system controller 210 may evaluate various communication conditions during the communications of 305, which may support selecting one antenna 170 for signal transmission to a common target device under some scenarios, and selecting multiple antennas 170 for signal transmission to a common target device under some other scenarios.

In some examples, during the communications of 305 (e.g., for signal transmission or reception using multiple antennas 170), the multiple antenna system 160 may support applying a time delay to a signal between the modem 280 and one or both of the first antenna 170 or the second antenna 170. For example, to support signal reception via both the first antenna 170 and the second antenna 170, a delay component 255 corresponding to the antenna 170 that is relatively closer to the target device may impose a time delay or a phase delay to signals received via the antenna 170 that is relatively closer to the target device. In another example, where applicable, to support signal transmission via both the first antenna 170 and the second antenna 170, a delay component 265 corresponding to the antenna 170 that is relatively closer to the target device may impose a time delay or a phase delay to signals to be transmitted via the antenna 170 that is relatively closer to the target device.

At 310, the method 300 may include determining to communicate with another target device (e.g., a second target device, such as a satellite 110-b). In some examples, the determination of 310 may include a determination to perform a handover (e.g., a complete handover, a partial handover) from communicating with one target device to communicating with another target device, or to otherwise supplement or combine communications via the other target device. In some examples, the determination of 310 may be based on a decision performed at an antenna system controller 210, which may be based on conditions of communications via the first target device (e.g., degrading communications, increasing signal-to-noise ratio (SNR), an elevation angle provided by a beamformer reaching or approaching a threshold), or based on current or impending loss of line-of-sight with the target device (e.g., based on a position or heading of the target device, or of the multiple antenna system 160, or of both), or based on other criteria that may be associated with initiating communications with a new target device.

In various examples, the determination to communicate with the other target device may be performed at the antenna system controller 210 based on measurements or other information stored at the antenna system controller 210, detected at the antenna system controller 210, received via one or more antenna 170, received via a data line 285, or various combinations thereof. In some other examples, such a decision may be performed at another device outside the antenna system controller 210, and the determination of 310 may be triggered or initiated using signaling received from outside the antenna system controller 210. In some examples, such a determination may include determining to hand over communications from one satellite 110 having a first orbital path to another satellite 110 having a different orbital path (e.g., a satellite 110 having a different location relative to the multiple antenna system 160, a satellite 110 having an orbital position or path that may provide improved communications characteristics).

At 315, based at least in part on determining to communicate with the other target device, the method 300 may include isolating the first antenna 170 from the modem 280 (e.g., isolating the antenna 170-c from the modem 280-a used for the communications of 305). In some examples, such an isolation may be provided by way of a switching component 270, or one or more other switching components having a different relative location than the switching component 270, which may be controlled by the antenna system controller 210. For example, the isolation of 315 may be provided by a switch or relay at any one or more locations along a signal path between the first antenna 170 and the modem 280, including a reception signal path, a transmission signal path, or both. During and after the isolation operations of 315 (e.g., through one or more of the operations of 315 through 335), the second antenna 170 may remain coupled with the modem 280 (e.g., at least intermittently), and accordingly may support ongoing communications with the original target devices (e.g., by maintaining alignment of a beam 175 associated with the second antenna 170 with the original target device).

For illustrative purposes, the “first antenna” as used herein (e.g., the antenna 170 isolated at 315) may refer to the antenna 170-c, as an example. However, in the context of the multiple antenna system 160-a, the isolation of 315, and subsequent related steps, may refer to an isolation of either the antenna 170-c, or the antenna 170-d, depending on the circumstances at 315. For example, the antenna system controller 210 may select among a set of antennas 170 to perform the isolation of 315, which may be selected based on various criteria. For example, the selection of an antenna 170 for the isolation of 315 may be made to avoid interference between the first and second antennas, such as physical interference (e.g., signal shadowing) or constructive or destructive transmission interference that may result from the antennas 170 being pointed toward different target devices. For example, the first antenna, for the isolation of 315, may be identified as being the antenna 170 that is closer or will be closer to the other (e.g., new) target device, whereas the second antenna (e.g., which may maintain communications with the original target device), may be identified as being relatively closer to the original target device. Such a selection between the first and second antennas 170 for the isolation of 315 may be performed based on various other criteria, or combinations of criteria, in addition to such line-of-sight or interference considerations.

At 320, the method 300 may include orienting the first antenna 170 toward the other target device. In some examples, the orienting of the first antenna 170 may include actuating an antenna positioning mechanism (e.g., positioning mechanism 180-c, using the positioning controller 220-a) to rotate the first antenna 170 about a positioning axis (e.g., about the positioning axis 173-c, an azimuth axis), which may align a signaling direction (e.g., a beam 175-c) toward the other target device. In some examples, the orienting of the first antenna 170 may include controlling a beamformer associated with the first antenna 170 (e.g., a reception beamformer 250-a, a transmission beamformer 260-a, or both) to align a signaling direction (e.g., a beam 175-c) about a beamforming axis 174 (e.g., beamforming axis 174-c, an elevation axis) toward the other target device.

At 325, the method 300 may include coupling the first antenna 170 with a modem 280 (e.g., based at least in part on based on aligning the signaling direction of the first antenna 170 toward the other target device). In some examples, the first antenna 170 may be coupled with a different modem 280 than the one used to support the communications with the original target device (e.g., a second modem, the modem 280-b), which may support communications via the first antenna 170 and the second antenna 170 concurrently. In some other examples, the first antenna 170 may be coupled with a same modem 280 as used to support the communications with the original target device (e.g., the modem 280-a), which may support intermittent or alternating communications using the first antenna 170 (e.g., with the original target device) or the second antenna 170 (e.g., with the new target device). In some examples, such intermittent or alternating communications may be supported by operating a switching component 270 in a time-domain switching or multiplexing configuration.

At 330, while the first antenna 170 is coupled with the modem 280 associated with the coupling operations of 325, the method 300 may include establishing communications with the other target device using the first antenna 170. Such communications establishment may be performed using unidirectional communications or bidirectional communications with the other target device using the first antenna 170 and the modem 280 coupled with the first antenna 170 at 325 (e.g., the modem 280-a or the modem 280-b), which may or may not be performed concurrently with communications with the original target device using the second antenna 170. In some such examples, a communications establishment of 330 may be supported by configuration signaling with the original target device (e.g., using the second antenna 170), such as handover configuration signaling.

In some examples, at 335, the method 300 may include determining to break communication with the original target device (e.g., the target device for the communications of 305). In some examples, such a determination may be based at least in part on communicating with the other target device using the first antenna 170 (e.g., determining to break communication upon or after the communications establishment of 330). In some examples, such a determination may be made after some duration of concurrent communication with the original target device and with the new target device. For example, the determination to break communications with the original target device may be based on concluding a communication session or completing reception of scheduled information, which may occur after performing some communications with the other target device using the first antenna 170. In some other examples, a determination to break communication with the original target device may be based on losing a line of sight between a target device and the multiple antenna system 160 (e.g., a target satellite 110 dropping below or approaching a horizon or being otherwise obscured) or a direction of signaling from the second antenna 170 satisfying a threshold (e.g., an elevation angle of a beam 175 satisfying a threshold, such as exceeding a beamforming capability), or a capability to maintain communications with the original target device falling below a threshold (e.g., an SNR threshold, a signal-to-interference-plus-noise (SINR) threshold), among other criteria.

At 340, the method 300 may include isolating the second antenna 170 from the modem (e.g., isolating the antenna 170-d from the modem 280-a, based on determining to break communication with the original target device). In some examples, such an isolation may be provided by way of a switching component 270, or one or more other switching components having a different relative location than the switching component 270, which may be controlled by the antenna system controller 210. For example, the isolation of 340 may be provided by a switch or relay at any one or more locations along a signal path between the second antenna 170 and the modem 280, including a reception signal path, or a transmission signal path, or both.

At 345, the method 300 may include orienting the second antenna 170 toward the other target device (e.g., after breaking communication with the prior target device, after isolating the second antenna 170 from the modem 280). In some examples, the orienting of the second antenna 170 may include actuating an antenna positioning mechanism (e.g., positioning mechanism 180-d) to rotate the second antenna 170 about a positioning axis (e.g., positioning axis 173-d, an azimuth axis), which may align a signaling direction (e.g., a beam 175-d) toward the other target device. In some examples, the orienting of the second antenna 170 may include controlling a beamformer associated with the second antenna 170 (e.g., a reception beamformer 250-b, a transmission beamformer 260-b, or both) to align a signaling direction (e.g., a beam 175-d) about a beamforming axis 174 (e.g., beamforming axis 174-d, an elevation axis) toward the other target device.

At 350, the method 300 may include coupling the first antenna 170 with a modem 280 (e.g., the modem 280-a or the modem 280-b), which may be based at least in part on based on aligning the signaling direction of the second antenna 170 toward the other target device. Accordingly, as part of the operations of 350, a communications capability of the second antenna may be combined with a communications capability of the first antenna (e.g., the first antenna 170 and the second antenna 170 may be coupled with a same modem 280). For example, signal power of a signal from the other target device received via the first antenna 170 may be combined with signal power of a signal from the other target device received via the second antenna 170 for input to the modem 280 (e.g., using a power combiner). In some examples, such a coupling may be with the same modem as used for the communications established at 330. In some other examples, the first antenna 170 may be coupled with a different modem 280 than the one used to support the communications established at 330 (e.g., the first modem, the modem 280-a), which may be followed by coupling the first antenna 170 with that same modem 280. In these and other examples, based at least in part on the coupling of 350, communications with the other target device may be supported by both the first antenna 170 and the second antenna 170, and the method may return to the operations of 305, which may include communicating with the new target device using the first antenna 170 and the second antenna 170, while the first antenna and the second antenna are coupled with the same modem 280. Such communications may be based at least in part on aligning the signaling direction of the first antenna 170 toward the new target device and aligning the signaling direction of the second antenna 170 toward the new device.

Although the example of method 300 is described with reference to transitioning communications from one target device to another target device, operations of the method 300 may be modified for other communications scenarios. For example, to support a temporary communications link with a second target device while maintaining a communications link with a first target device, the method 300 may, at 310, include determining to communicate with the second target device and, at 335, the operations of the method 300 may be modified to include determine to break communications with the second target device. Accordingly, at 345, the method 300 may be modified to orient the second antenna 170 toward the first target device. In some examples, such techniques may be implemented in circumstances where the communications of 305 are performed with a geostationary satellite 110, and the second target device is a LEO or MEO satellite 110 that is available temporarily (e.g., for a duration over which a line of sight can be maintained). In such examples, the multiple antenna system 160 may support communicating with the geostationary satellite 110 using both antennas 170, and temporarily decoupling and reorienting one of the antennas 170 to support a temporary communications link with the LEO or MEO satellite 110, before returning to communications with the geostationary satellite 110 using both antennas.

Further, although the example of method 300 is described with reference to a multiple antenna system 160 having two antennas 170, the described techniques may be extended to a multiple antenna system 160 having any quantity of two or more antennas 170. For example, the communications of 305 may be modified to refer to communications using any set of two or more antennas 170 coupled with a same modem 280, and the isolation, orientation, coupling, and communication operations of 315 through 330 may refer to any subset of the antennas 170 (e.g., one or more of the set of antennas 170) for communicating with a new target device. In some examples, such techniques also may be extended to more than two target devices, such that the isolation, orientation, coupling, and communication operations of 315 through 330 may be repeated for any quantity of one or more target devices, where such operations may or may not be performed concurrently.

In some examples, including multiple modems 280 in a multiple antenna system 160 may support swapping between modems 280 in successive transitions from one target device to another. An example of such techniques may be described with reference to components of the multiple antenna system 160-a of FIG. 2, in the context of multiple iterations of the operations of method 300. For example, a first iteration of the operations of 305 (e.g., communications with a first target device) may be supported by the antenna 170-c and the antenna 170-d being coupled with the modem 280-a. To support establishing communications with a second target device, the antenna 170-c may be isolated from the modem 280-a during a first iteration of the operations of 315, and the antenna 170-c may be coupled with the modem 280-b during a first iteration of the operations of 325. These operations may be followed by the antenna 170-d being isolated from the modem 280-a during a first iteration of the operations of 340 and the antenna 170-d being coupled with the modem 280-b during a first iteration of the operations of 350. Accordingly, a second iteration of the operations of 305 (e.g., communications with the second target device) may be supported by the antenna 170-c and the antenna 170-d being coupled with the modem 280-b. To support establishing communications with a third target device, the antenna 170-c may be isolated from the modem 280-b during a second iteration of the operations of 315, and the antenna 170-c may be coupled with the modem 280-a during a second iteration of the operations of 325. These operations may be followed by the antenna 170-d being isolated from the modem 280-b during a second iteration of the operations of 340 and the antenna 170-d being coupled with the modem 280-a during a second iteration of the operations of 350.

Accordingly, a third iteration of the operations of 305 (e.g., communications with the third target device) may be supported by the antenna 170-c and the antenna 170-d being coupled with the modem 280-a. Although, in the above example, the antenna 170-c is associated with each iteration of the isolation operations of 315, in various examples, either the antenna 170-c or the antenna 170-d may be selected for isolation during a respective iteration based on various criteria in accordance with examples as disclosed herein.

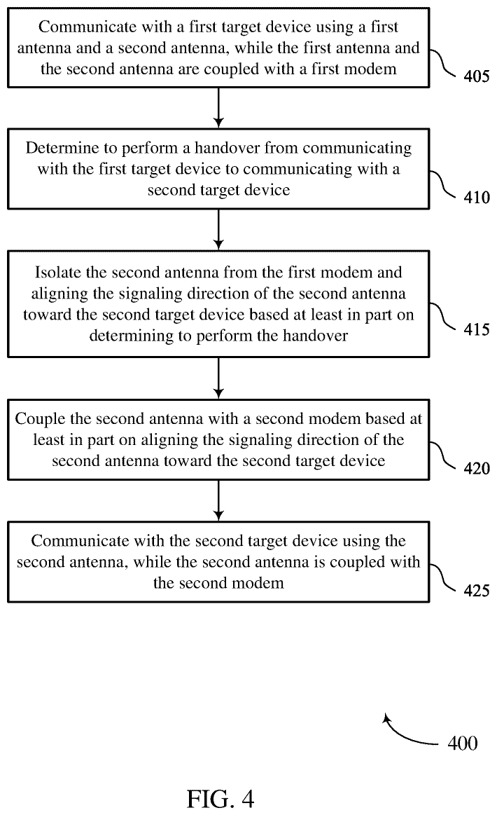

FIG. 4 shows a flowchart illustrating a method 400 that supports techniques for communications using multiple antennas in accordance with examples as disclosed herein. The operations of the method 400 may be implemented by an antenna system (e.g., a multiple antenna system 160) or its components as described herein. For example, the operations of the method 400 may be performed by an antenna system as described with reference to FIGS. 1 through 3. In some examples, an antenna system may execute a set of instructions to control the functional elements of the antenna system to perform the described functions. Additionally, or alternatively, the antenna system may perform aspects of the described functions using special-purpose hardware.

At 405, the method may include communicating with a first target device (e.g., a first satellite 110) using a first antenna (e.g., a first antenna 170) and a second antenna (e.g., a second antenna 170), while the first antenna and the second antenna are coupled with a first modem (e.g., a first modem 280). The communicating of 505 may be based at least in part on aligning a signaling direction of the first antenna (e.g., a beam 175 of the first antenna) and a signaling direction of the second antenna (e.g., a beam 175 of the second antenna) toward the first target device.

At 410, the method may include determining to perform a handover from communicating with the first target device to communicating with a second target device (e.g., a second satellite 110). In some examples, the determination to perform the handover may be performed by an antenna system controller 210, which may be based on a calculation or decision of the antenna system controller 210, or may be based on a command or other initiating or informational signal received by an antenna system controller 210 (e.g., from another entity of a communication system 100), or some combination thereof.

At 415, the method may include isolating the second antenna from the first modem and aligning the signaling direction of the second antenna toward the second target device based at least in part on determining to perform the handover. In some examples, aligning the signaling direction of the second antenna toward the second target device may include actuating an antenna positioning mechanism (e.g., a positioning mechanism 180) to rotate (e.g., physically rotate) the second antenna about a positioning axis (e.g., a positioning axis 173). In some examples, isolating the second antenna from the first modem may be supported by a switching component 270, or portion thereof, coupled between the second antenna and the first modem.

At 420, the method may include coupling the second antenna with a second modem based at least in part on aligning the signaling direction of the second antenna toward the second target device. In some examples, aspects of the operations of 420 may be performed by. In some examples, coupling the second antenna with the second modem may be supported by a switching component 270, or portion thereof, coupled between the second antenna and the second modem.

At 425, the method may include communicating with the second target device using the second antenna, while the second antenna is coupled with the second modem.

In some examples, an apparatus as described herein may perform a method or methods, such as the method 400. The apparatus may include features, circuitry, logic, means, or instructions (e.g., a non-transitory computer-readable medium storing instructions executable by a processor) for: communicating with a first target device using a first antenna and a second antenna, while the first antenna and the second antenna are coupled with a first modem, (e.g., based at least in part on aligning a signaling direction of the first antenna and a signaling direction of the second antenna toward the first target device); determining to perform a handover from communicating with the first target device to communicating with a second target device; isolating the second antenna from the first modem and aligning the signaling direction of the second antenna toward the second target device based at least in part on determining to perform the handover (e.g., where aligning the signaling direction of the second antenna toward the second target device may include actuating an antenna positioning mechanism to rotate the second antenna about a positioning axis); coupling the second antenna with a second modem based at least in part on aligning the signaling direction of the second antenna toward the second target device; and communicating with the second target device using the second antenna, while the second antenna is coupled with the second modem.

Some examples of the method 400 and the apparatus described herein may further include operations, features, means, or instructions for communicating with the first target device using the first antenna during the aligning of the signaling direction of the second antenna toward the second target device.

Some examples of the method 400 and the apparatus described herein may further include operations, features, means, or instructions for: aligning the signaling direction of the first antenna toward the second target device, where aligning the signaling direction of the first antenna toward the second target device may include actuating a second antenna positioning mechanism (e.g., a second positioning mechanism 180) to rotate the first antenna about a second positioning axis (e.g., a second positioning axis 173) that is different than the positioning axis; coupling the first antenna with the second modem based at least in part on aligning the signaling direction of the first antenna toward the second target device; and communicating with the second target device using the first antenna and the second antenna, while the first antenna and the second antenna may be coupled with the second modem (e.g., based at least in part on aligning the signaling direction of the first antenna toward the second target device and aligning the signaling direction of the second antenna toward the second target device).

Some examples of the method 400 and the apparatus described herein may further include operations, features, means, or instructions for: isolating the first antenna from the first modem based at least in part on communicating with the second target device using the second antenna; and aligning the signaling direction of the first antenna toward the second target device after isolating the first antenna from the first modem.

In some examples of the method 400 and the apparatus described herein, communicating with the first target device using the first antenna and the second antenna may include operations, features, circuitry, logic, means, or instructions for coupling (e.g., via a reception power splitter or switch) the first modem with both the first antenna and the second antenna for receiving signals from the first target device and coupling (e.g., via a transmission power splitter or switch) the first modem with a selected one of the first antenna or the second antenna for transmitting signals to the first target device.

Some examples of the method 400 and the apparatus described herein may further include operations, features, means, or instructions for selecting the one of the first antenna or the second antenna for the transmitting signals to the first target device based at least in part on a relative position between the first antenna and the second antenna and either the aligned signaling direction of the first antenna or the aligned signaling direction of the second antenna.

Some examples of the method 400 and the apparatus described herein may further include operations, features, means, or instructions for selecting the one of the first antenna or the second antenna for the transmitting signals to the first target device based at least in part on a relative proximity between the first antenna and the first target device, or a relative proximity between the second antenna and the first target device, or a combination thereof.

In some examples of the method 400 and the apparatus described herein, communicating with the first target device using the first antenna and the second antenna may include operations, features, circuitry, logic, means, or instructions for applying a time delay to a signal between the first modem and one of the first antenna or the second antenna.

Some examples of the method 400 and the apparatus described herein may further include operations, features, means, or instructions for selecting the second antenna for isolating from the first modem based at least in part on a position of the second target device.

In some examples of the method 400 and the apparatus described herein, aligning the signaling direction of the first antenna may include operations, features, circuitry, logic, means, or instructions for electronically forming a beam of the first antenna about a first beamforming axis, and aligning the signaling direction of the second antenna may include operations, features, circuitry, logic, means, or instructions for electronically forming a beam of the second antenna about a second beamforming axis.

In some examples of the method 400 and the apparatus described herein, the positioning axis may be an azimuth axis and the first beamforming axis, or the second beamforming axis, or both may be an elevation axis.

In some examples of the method 400 and the apparatus described herein, the first target device may include a first satellite associated with a first orbital characteristic and the second target device may include a second satellite associated with a second orbital characteristic.

In some examples of the method 400 and the apparatus described herein, the first modem and the second modem may be the same modem (e.g., in implementations where the first antenna and the second antenna may be coupled with the same modem in accordance with a time domain switching or multiplexing).

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

An apparatus for wireless communications is described. The apparatus may include: a base (e.g., a base 190); a first antenna (e.g., a first antenna 170) including a first array of antenna elements (e.g., a first phased array, a first array of antenna elements 171); a first alignment controller operable to control a direction of signaling via the first array of antenna elements; a second antenna (e.g., a second antenna 170) including a second array of antenna elements (e.g., a second phased array, a second array of antenna elements 171); a second alignment controller operable to control a direction of signaling via the second array of antenna elements; a modem (e.g., a modem 280); and a switching component (e.g., a switching component 270).

In some examples, the first alignment controller may include or be otherwise associated with a first positioning mechanism (e.g., a positioning mechanism 180), which may be operable to rotate the first antenna relative to the base about a first axis (e.g., in or along an azimuth direction, about an azimuth axis, a first mechanical axis, a positioning axis 173), and a first beamformer (e.g., a reception beamformer 250, a transmission beamformer 260, or both), which may be operable to align a beam of the first antenna about a second axis (e.g., in or along an elevation direction, about an elevation axis, a first beamforming axis, a beamforming axis 174) of the first antenna. In some examples, the second alignment controller may include or be otherwise associated with a second positioning mechanism (e.g., a second positioning mechanism 180), which may be operable to rotate the second antenna relative to the base about a third axis (e.g., in or along an azimuth direction, about an azimuth axis, a second mechanical axis, a positioning axis 173), and a second beamformer (e.g., a reception beamformer 250, a transmission beamformer 260, or both), which may be operable to align a beam of the second antenna about a fourth axis (e.g., in or along an elevation direction, about an elevation axis, a second beamforming axis, a beamforming axis 174) of the second antenna.

In some examples, the first array of antenna elements may have a fixed tilt relative to the base. Additionally, or alternatively, in some examples, the second array of antenna elements may have a fixed tilt relative to the base, which may be the same as or different than a tilt associated with the first array of antenna elements.

In some examples, the switching component may be operable to couple the modem with the first antenna while the modem is isolated from the second antenna, and to couple the modem with the second antenna while the modem is isolated from the first antenna, and to couple the modem with the first antenna and the second antenna (e.g., simultaneously, concurrently, during a same duration).

Some examples of the apparatus may further include a first reception amplifier (e.g., a reception amplifier 230) coupled with the first antenna, and a second reception amplifier (e.g., a reception amplifier 230) coupled with the second antenna. In some examples (e.g., for signal reception), the switching component may be operable to couple the modem with the first reception amplifier and the second reception amplifier simultaneously (e.g., in a configuration to use both reception amplifiers for signal reception).

Some examples of the apparatus may further include a reception amplifier coupled with the modem (e.g., a common reception amplifier 230 that may support communications via either or both of the first antenna or the second antenna). In some examples (e.g., for signal reception), the switching component may be operable to couple the reception amplifier with the first antenna and the second antenna (e.g., concurrently, simultaneously, during a same duration).

Some examples of the apparatus may further include a first transmission amplifier (e.g., a transmission amplifier 240) coupled with the first antenna and a second transmission amplifier (e.g., a transmission amplifier 240) coupled with the second antenna. In some examples (e.g., for signal transmission), the switching component may be operable to couple the first transmission amplifier with the modem while the second transmission amplifier is isolated from the modem, or to couple the couple the second transmission amplifier with the modem while the first transmission amplifier is isolated from the modem (e.g., in a configuration to use one, but not both transmission amplifier for signal transmissions).

Some examples of the apparatus may further include a transmission amplifier coupled with the modem (e.g., a common transmission amplifier 240 that may support communications via either or both of the first antenna or the second antenna). In some examples (e.g., for signal transmission), the switching component may be operable to couple the transmission amplifier with the first antenna while the transmission amplifier is isolated from the second antenna, and to couple the transmission amplifier with the second antenna while the transmission amplifier is isolated from the first antenna.

Some examples of the apparatus may further include a delay component (e.g., a delay component 255, a delay component 265, or both) operable to apply a time delay to a signal between the modem and one of the first antenna or the second antenna during the concurrent coupling of the modem with the first antenna and the second antenna.

Some examples of the apparatus may further include a controller (e.g., an antenna system controller 210) operable to cause the apparatus to: communicate with a first target device (e.g., a satellite 110) using the first antenna and the second antenna, while the first antenna and the second antenna are coupled with the modem (e.g., based at least in part on the first alignment controller aligning the direction of signaling via the first antenna toward the first target device and the second alignment controller aligning the direction of signaling via the second antenna toward the first target device); determine to perform a handover or other transition or supplementation from communicating with the first target device to communicating with at least a second target device; isolate the second antenna from the modem and cause the second alignment controller to align the direction of signaling via the second antenna toward the second target device based at least in part on determining to perform the handover or other transition or supplementation; couple the second antenna with a second modem based at least in part on the second alignment controller aligning the direction of signaling via the second antenna toward the second target device; and communicate with the second target device using the second antenna, while the second antenna is coupled with the second modem.

In some examples of the apparatus, the controller may be operable to cause the apparatus to communicate with the first target device using the first antenna during at least the aligning of the direction of signaling via the second antenna toward the second target device.

In some examples of the apparatus, the controller may be operable to cause the apparatus to: align the direction of signaling via the first antenna toward the second target device; couple the first antenna with the second modem based at least in part on aligning the direction of signaling via the first antenna toward the second target device; and communicate with the second target device using the first antenna and the second antenna, while the first antenna and the second antenna are coupled with the second modem (e.g., based at least in part on aligning the direction of signaling via the first antenna toward the second target device and aligning the direction of signaling via the second antenna toward the second target device).

In some examples of the apparatus, the controller may be operable to cause the apparatus to isolate the first antenna from the modem based at least in part on communicating with the second target device using the second antenna, and align the direction of signaling via the first antenna toward the second target device after isolating the first antenna from the modem.

In some examples of the apparatus, to communicate with the first target device using the first antenna and the second antenna, the controller may be operable to cause the apparatus to couple the modem with both the first antenna and the second antenna for receiving signals from the first target device, and couple a selected one of the first antenna or the second antenna (e.g., but not both) for transmitting signals to the first target device.

In some examples of the apparatus, the controller may be operable to cause the apparatus to select the one of the first antenna or the second antenna for the transmitting signals to the first target device based at least in part on a relative position between the first antenna and the second antenna and either the direction of signaling via the first antenna or the direction of signaling via the second antenna.

In some examples of the apparatus, the controller may be operable to cause the apparatus to select the one of the first antenna or the second antenna for the transmitting signals to the first target device based at least in part on a relative proximity between the first antenna and the first target device, or a relative proximity between the second antenna and the first target device, or a combination thereof.

In some examples of the apparatus, the controller may be operable to cause the apparatus to select the second antenna for isolating from the first modem based at least in part on a position of the second target device.

In some examples of the apparatus, the modem and the second modem may be the same modem (e.g., a common or shared modem, a modem that may support communications with either the first antenna or the second antenna in accordance with a time domain multiplexing or switching). Some examples of the apparatus may further include the second modem, the second modem being different than the modem.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, the described functions described can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) read-only memory (ROM) or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications, comprising:
communicating with a first target device using a first antenna and a second antenna, while the first antenna and the second antenna are coupled with a first modem, based at least in part on aligning a signaling direction of the first antenna and a signaling direction of the second antenna toward the first target device;
determining to perform a handover from communicating with the first target device to communicating with a second target device;
isolating the second antenna from the first modem and aligning the signaling direction of the second antenna toward the second target device based at least in part on determining to perform the handover, wherein aligning the signaling direction of the second antenna toward the second target device comprises actuating an antenna positioning mechanism to rotate the second antenna about a positioning axis;
coupling the second antenna with a second modem based at least in part on aligning the signaling direction of the second antenna toward the second target device; and
communicating with the second target device using the second antenna, while the second antenna is coupled with the second modem.

2. The method of claim 1, further comprising:
communicating with the first target device using the first antenna during the aligning of the signaling direction of the second antenna toward the second target device.

3. The method of claim 1, further comprising:
aligning the signaling direction of the first antenna toward the second target device, wherein aligning the signaling direction of the first antenna toward the second target device comprises actuating a second antenna positioning mechanism to rotate the first antenna about a second positioning axis that is different than the positioning axis;
coupling the first antenna with the second modem based at least in part on aligning the signaling direction of the first antenna toward the second target device; and
communicating with the second target device using the first antenna and the second antenna, while the first antenna and the second antenna are coupled with the second modem, based at least in part on aligning the signaling direction of the first antenna toward the second target device and aligning the signaling direction of the second antenna toward the second target device.

4. The method of claim 3, further comprising:
isolating the first antenna from the first modem based at least in part on communicating with the second target device using the second antenna; and
aligning the signaling direction of the first antenna toward the second target device after isolating the first antenna from the first modem.

5. The method of claim 1, wherein communicating with the first target device using the first antenna and the second antenna comprises:
coupling the first modem with both the first antenna and the second antenna for receiving signals from the first target device; and
coupling the first modem with a selected one of the first antenna or the second antenna for transmitting signals to the first target device.

6. The method of claim 5, further comprising:
selecting the one of the first antenna or the second antenna for the transmitting signals to the first target device based at least in part on a relative position between the first antenna and the second antenna and either the aligned signaling direction of the first antenna or the aligned signaling direction of the second antenna.

7. The method of claim 5, further comprising:
selecting the one of the first antenna or the second antenna for the transmitting signals to the first target device based at least in part on a relative proximity between the first antenna and the first target device, or a relative proximity between the second antenna and the first target device, or a combination thereof.

8. The method of claim 1, wherein communicating with the first target device using the first antenna and the second antenna comprises:
applying a time delay to a signal between the first modem and one of the first antenna or the second antenna.

9. The method of claim 1, further comprising:
selecting the second antenna for isolating from the first modem based at least in part on a position of the second target device.

10. The method of claim 1, wherein:
aligning the signaling direction of the first antenna comprises electronically forming a beam of the first antenna about a first beamforming axis; and
aligning the signaling direction of the second antenna comprises electronically forming a beam of the second antenna about a second beamforming axis.

11. The method of claim 10, wherein the positioning axis is an azimuth axis and the first beamforming axis is an elevation axis.

12. The method of claim 1, wherein the first target device comprises a first satellite associated with a first orbital characteristic and the second target device comprises a second satellite associated with a second orbital characteristic.

13. The method of claim 1, wherein the first modem and the second modem are the same modem.

14. An apparatus for wireless communications, comprising:
a base;
a first antenna comprising a first array of antenna elements having a fixed tilt relative to the base;
a first alignment controller operable to control a direction of signaling via the first array of antenna elements, wherein the first alignment controller comprises a first positioning mechanism operable to rotate the first antenna relative to the base about a first azimuth axis and a first beamformer operable to align a beam of the first antenna about an elevation axis of the first antenna;
a second antenna comprising a second array of antenna elements having a fixed tilt relative to the base;
a second alignment controller operable to control a direction of signaling via the second array of antenna elements, wherein the second alignment controller comprises a second positioning mechanism operable to rotate the second antenna relative to the base about a second azimuth axis and a second beamformer operable to align a beam of the second antenna about an elevation axis of the second antenna;
a modem; and
a switching component operable to couple the modem with the first antenna while the modem is isolated from the second antenna, and to couple the modem with the second antenna while the modem is isolated from the first antenna, and to couple the modem with the first antenna and the second antenna concurrently.

15. The apparatus of claim 14, further comprising:
a first reception amplifier coupled with the first antenna; and
a second reception amplifier coupled with the second antenna,
wherein, for signal reception, the switching component is operable to couple the modem with the first reception amplifier and the second reception amplifier concurrently.

16. The apparatus of claim 14, further comprising:
a reception amplifier coupled with the modem,
wherein, for signal reception, the switching component is operable to couple the reception amplifier with the first antenna and the second antenna concurrently.

17. The apparatus of claim 14, further comprising:
a first transmission amplifier coupled with the first antenna; and
a second transmission amplifier coupled with the second antenna,
wherein, for signal transmission, the switching component is operable to couple the first transmission amplifier with the modem while the second transmission amplifier is isolated from the modem, or to couple the second transmission amplifier with the modem while the first transmission amplifier is isolated from the modem.

18. The apparatus of claim 14, further comprising:
a transmission amplifier coupled with the modem,
wherein, for signal transmission, the switching component is operable to couple the transmission amplifier with the first antenna while the transmission amplifier is isolated from the second antenna, and to couple the transmission amplifier with the second antenna while the transmission amplifier is isolated from the first antenna.

19. The apparatus of claim 14, further comprising:
a delay component operable to apply a time delay to a signal between the modem and one of the first antenna or the second antenna during the concurrent coupling of the modem with the first antenna and the second antenna.

20. The apparatus of claim 14, further comprising a controller operable to cause the apparatus to:
communicate with a first target device using the first antenna and the second antenna, while the first antenna and the second antenna are coupled with the modem, based at least in part on the first alignment controller aligning the direction of signaling via the first antenna toward the first target device and the second alignment controller aligning the direction of signaling via the second antenna toward the first target device;
determine to perform a handover from communicating with the first target device to communicating with a second target device;
isolate the second antenna from the modem and cause the second alignment controller to align the direction of signaling via the second antenna toward the second target device based at least in part on determining to perform the handover;
couple the second antenna with a second modem based at least in part on the second alignment controller aligning the direction of signaling via the second antenna toward the second target device; and
communicate with the second target device using the second antenna, while the second antenna is coupled with the second modem.

21. The apparatus of claim 20, wherein the controller is operable to cause the apparatus to:
communicate with the first target device using the first antenna during the aligning of the direction of signaling via the second antenna toward the second target device.

22. The apparatus of claim 20, wherein the controller is operable to cause the apparatus to:
align the direction of signaling via the first antenna toward the second target device;
couple the first antenna with the second modem based at least in part on aligning the direction of signaling via the first antenna toward the second target device; and
communicate with the second target device using the first antenna and the second antenna, while the first antenna and the second antenna are coupled with the second modem, based at least in part on aligning the direction of signaling via the first antenna toward the second target device and aligning the direction of signaling via the second antenna toward the second target device.

23. The apparatus of claim 20, wherein the controller is operable to cause the apparatus to:
isolate the first antenna from the modem based at least in part on communicating with the second target device using the second antenna; and
align the direction of signaling via the first antenna toward the second target device after isolating the first antenna from the modem.

24. The apparatus of claim 20, wherein, to communicate with the first target device using the first antenna and the second antenna, the controller is operable to cause the apparatus to:
couple the modem with both the first antenna and the second antenna for receiving signals from the first target device; and
couple a selected one of the first antenna or the second antenna for transmitting signals to the first target device.

25. The apparatus of claim 24, wherein the controller is operable to cause the apparatus to:
select the one of the first antenna or the second antenna for the transmitting signals to the first target device based at least in part on a relative position between the first antenna and the second antenna and either the direction of signaling via the first antenna or the direction of signaling via the second antenna.

26. The apparatus of claim 24, wherein the controller is operable to cause the apparatus to:
select the one of the first antenna or the second antenna for the transmitting signals to the first target device based at least in part on a relative proximity between the first antenna and the first target device, or a relative proximity between the second antenna and the first target device, or a combination thereof.

27. The apparatus of claim 20, wherein the controller is operable to cause the apparatus to:
select the second antenna for isolating from the modem based at least in part on a position of the second target device.

28. The apparatus of claim 20, wherein the modem and the second modem are the same modem.

29. The apparatus of claim 20, further comprising:
the second modem, the second modem being different than the modem.

30-42. (canceled)
